(19) United States
(12) Patent Application Publication
(10) Pub. No.: US 2005/0210096 A1
(43) Pub. Date: Sep. 22, 2005

(54) Method and system for agentless discovery of application infrastructure resources

(76) Inventors: Thomas P. Bishop, Austin, TX (US); James Morse Mott, Austin, TX (US)

Correspondence Address: TOLER & LARSON & ABEL L.L.P., 5000 PLAZA ON THE LAKE STE 265, AUSTIN, TX, 78746, US

(21) Appl. No.: 10/803,155

(22) Filed: Mar. 17, 2004

(51) Int. Cl. G06F 7/00

(52) U.S. Cl. 709/200

(57) ABSTRACT

Systems and methods are described which allow information to be assembled on an application infrastructure topology. This application infrastructure topology may be assembled from information collected on various application infrastructure components in the application infrastructure. Information may be collected on an application infrastructure component in an application infrastructure by examining communications intended for, or originating with, the application infrastructure component. Information may also be collected on an application infrastructure component by querying an agent on the application infrastructure component. By exploiting the protocol of the network, these queries may be issued with a minimum of intrusiveness. The data on the various application infrastructure components may then be aggregated, and information on the application infrastructure topology assembled.

### TECHNICAL FIELD OF THE INVENTION

The invention relates in general to methods and systems for managing and controlling application infrastructure components in an application infrastructure, and more particularly, to methods and systems for discovering, measuring and controlling resources of an application infrastructure and its application infrastructure components.

### BACKGROUND OF THE INVENTION

In today's rapidly changing marketplace, electronically disseminating information about the goods and services businesses have to offer is important to them regardless of size. To accomplish this efficiently, and comparatively inexpensively, many businesses have set up application infrastructures, one example of which is a site on the World Wide Web. These sites provide information on the products or services the business provides, the size, structure, and location of the business; or any other type of information which the business may wish people to access.

As these information systems grow increasingly complex, the application infrastructures which support these systems are growing increasingly complex as well. To facilitate the implementation and efficiency of these application infrastructures, a mechanism by which an application infrastructure may be automatically managed and controlled is desirable.

Managing and controlling an application infrastructure, however, presents a long list of difficulties. Not the least of these difficulties is the heterogeneity of application infrastructures. In order to observe an application infrastructure's behavior, a management and control solution should be able to observe the application infrastructure and alter it accordingly. To accomplish this, a management solution should have some notion how various components of an application infrastructure relate to one another. This allows a model of the application infrastructure to be constructed, and this model can then be used to tailor the behavior of the application infrastructure to the various workloads placed upon it.

Obtaining this information is difficult, however, as a variety of different environments may exist in a particular application infrastructure, and each of these environments may use an assortment of operating systems such as Linux, Windows, or AIX. Additionally, many different applications may run on each of these operating systems, as well as many different components of middleware, such as a Java based application server, and different and heterogeneous application infrastructures. These factors make collecting information on these environments, portions of the application infrastructure and applications rather difficult.

Traditionally, agents have been deployed on each device in an application infrastructure in order to collect a variety of data about the device and the applications executing on the device. This approach, however, has many drawbacks. A resident agent should be tailored specifically to the operating system and applications executing on the device. Not only does the agent require a significant initial expenditure, but in addition, every time an operating system or application is updated or changed, so must the agent. These constant fluctuations make development and deployment of these resident agents a daunting proposition, especially for a complex application infrastructure. Furthermore, these resident agents are software components having code that is executing on a device, meaning that a resident agent is a drain on not only the resources of the device on which it executes, but also other parts and potentially all of the application infrastructure as well. Every cycle that a device spends executing an instruction for an agent is a cycle that the device is kept from executing functionality associated with the application environment itself.

Thus, a need exists for methods and systems which can monitor, assess, and control devices, application infrastructure components and applications in an application infrastructure without the need to be individually adapted to the application infrastructure components and applications themselves.

### SUMMARY OF THE INVENTION

Systems and methods for collecting data on an application infrastructure are disclosed. These systems and methods allow data to be collected on various application infrastructure components in the application infrastructure and information on an application infrastructure topology to be assembled from the collected data. In many embodiments, data may be collected on an application infrastructure component in an application infrastructure by querying agents resident on the application infrastructure component. By exploiting the protocol used by the network, these agents may be queried more efficiently. In other embodiments, data may be collected on a application infrastructure component by observing traffic on the application infrastructure. A communication intended for an application infrastructure component is received, examined, and forwarded on to its intended destination.

In one embodiment, a method of collecting data regarding an application infrastructure component comprises receiving a communication pertaining to the application infrastructure component, examining the communication to obtain a characteristic of the application infrastructure component, and forwarding the communication.

In another embodiment, data is collected regarding one or more application infrastructure components coupled to the network by receiving a request for an application infrastructure component, and collecting data on the application infrastructure component by sending another request to the application infrastructure component and receiving a response to this request.

In some embodiments, a first request is received for an application infrastructure component and data is collected on the application infrastructure component by sending a second request to the application infrastructure component and receiving a reply to this second request.

In one embodiment, the first request may be forwarded to the application infrastructure component and a reply received for this first request.

In still other embodiments, the second request queries an agent residing on the application infrastructure component.

In yet other embodiments, a management component receives a TCP/IP packet intended for an application infrastructure component, the layers of the TCP/IP packet are examined, and the packet is forwarded to the intended recipient.

In still other embodiments, an application infrastructure topology is assembled from information collected on the application infrastructure components in the application infrastructure.

In similar embodiments, the application infrastructure topology may be represented in graph form.

Additionally, systems and apparatuses are presented which embody these methodologies in computer systems, hardware, and software.

These, and other, aspects of the invention will be better appreciated and understood when considered in conjunction with the following description and the accompanying drawings. A reader should be understood, however, that the following description, while indicating various embodiments of the invention and numerous specific details thereof, is given by way of illustration and not of limitation. Many substitutions, modifications, additions or rearrangements may be made within the scope of the invention, and the invention includes all such substitutions, modifications, additions or rearrangements.

### BRIEF DESCRIPTION OF THE DRAWINGS

The drawings accompanying and forming part of this specification are included to depict certain aspects of the invention. A clearer understanding of the invention, and of the components and operation of systems provided with the invention, will become more readily apparent by referring to the exemplary, and therefore nonlimiting, embodiments illustrated in the drawings, wherein identical reference numerals designate the same components. It should be noted that the features illustrated in the drawings are not necessarily drawn to scale.

FIG. 1 includes an illustration of a hardware configuration of a system for managing and controlling an application that runs in an application infrastructure.

FIG. 2 includes an illustration of a hardware configuration of the application management and control appliance in FIG. 1.

FIG. 3 includes an illustration of hardware configuration of one of the management blades in FIG. 2.

FIG. 4 includes an illustration of a process flow diagram for a method of formulating an application infrastructure topology from information collected on the application infrastructure components in the application infrastructure.

FIG. 5 includes more detailed illustrations of a method for collecting information from an application infrastructure component in an application infrastructure; and

FIG. 6 includes an illustration of a process flow diagram for another method of collecting information from a device in an application infrastructure.

### DESCRIPTION OF PREFERRED EMBODIMENTS

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. Skilled artisans should understand, however, that the detailed description and the specific examples, while disclosing preferred embodiments of the invention, are given by way of illustration only and not by way of limitation. Various substitutions, modifications, additions or rearrangements within the scope of the underlying inventive concept will become apparent to those skilled in the art after reading this disclosure.

Reference is now made in detail to the exemplary embodiments of the invention, examples of which are illustrated in the accompanying drawings. Wherever possible, the same reference numbers will be used throughout the drawings to refer to the same or like parts (elements).

A few terms are defined or clarified to aid in understanding those terms as used throughout this specification. The term “application infrastructure component” is intended to mean any part of an application infrastructure associated with an application. Application infrastructure components may be hardware, software, firmware, or virtual application infrastructure components. Many levels of abstraction are possible. For example, a server may be an application infrastructure component of a system, a CPU may be an application infrastructure component of the server, a register may be an application infrastructure component of the CPU, etc. For the purposes of this specification, application infrastructure component and resource are used interchangeably.

The term “application infrastructure” is intended to mean any and all hardware, software, and connected to an application management and control appliance. The hardware can include servers and other computers, data storage and other memories, switches and routers, and the like. The software used may include operating systems.

The term “application infrastructure topology” is intended to mean the interaction and coupling of components, devices, and application environments in a particular application infrastructure, or area of an application infrastructure.

The term “central management component” is intended to mean a component which is capable of obtaining information from management components, evaluating this information, and controlling or tuning an application infrastructure according to a specified set of goals. A control blade is an example of a central management component.

The term “characteristic” when used with reference to an application infrastructure component is intended to mean a piece of data regarding an application infrastructure of which the application infrastructure component is a part, excluding network addresses.

The term “component” is intended to mean any part of a managed and controlled application infrastructure, and may include all hardware, software, firmware, middleware, or virtual components associated with the managed and controlled application infrastructure. This term encompasses central management components, management components (e.g. management interface components), application infrastructure components and the hardware, software and firmware which comprise each of them.

The term “device” is intended to mean a hardware component which may be part of an application infrastructure, including computers such as web servers, application servers and database servers, storage sub-networks, routers, load balancers, etc., and other application middleware or application infrastructure components.

The term “management interface component” is intended to mean a component placed in the flow of traffic on a network operable to control and obtain information about traffic and devices in the application infrastructure. A management blade is an example of a management interface component.

As used herein, the terms “comprises,” “comprising,” “includes,” “including,” “has,” “having” and any variations thereof, are intended to cover a non-exclusive inclusion. For example, a method, process, article, or appliance that comprises a list of elements is not necessarily limited to only those elements but may include other elements not expressly listed or inherent to such method, process, article, or appliance. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

Unless otherwise defined, all technical and scientific terms used herein have the same meaning as commonly understood by one of ordinary skill in the art to which this invention belongs. Although methods, hardware, software, and firmware similar or equivalent to those described herein can be used in the practice or testing of the present invention, suitable methods, hardware, software, and firmware are described below. All publications, patent applications, patents, and other references mentioned herein are incorporated by reference in their entirety. In case of conflict, the present specification, including definitions, will control. In addition, the methods, hardware, software, and firmware and examples are illustrative only and not intended to be limiting.

Unless stated otherwise, components may be bi-directionally or uni-directionally coupled to each other. Coupling should be construed to include direct electrical connections and any one or more of intervening switches, resistors, capacitors, inductors, and the like between any two or more components.

To the extent not described herein, many details regarding specific network, hardware, software, firmware components and acts are conventional and may be found in textbooks and other sources within the computer, information technology, and networking arts.

Before discussing embodiments of the present invention, a non-limiting, exemplary hardware architecture for using embodiments of the present invention is described. After reading this specification, skilled artisans will appreciate that many other hardware architectures can be used in carrying out embodiments described herein and to list every one would be nearly impossible.

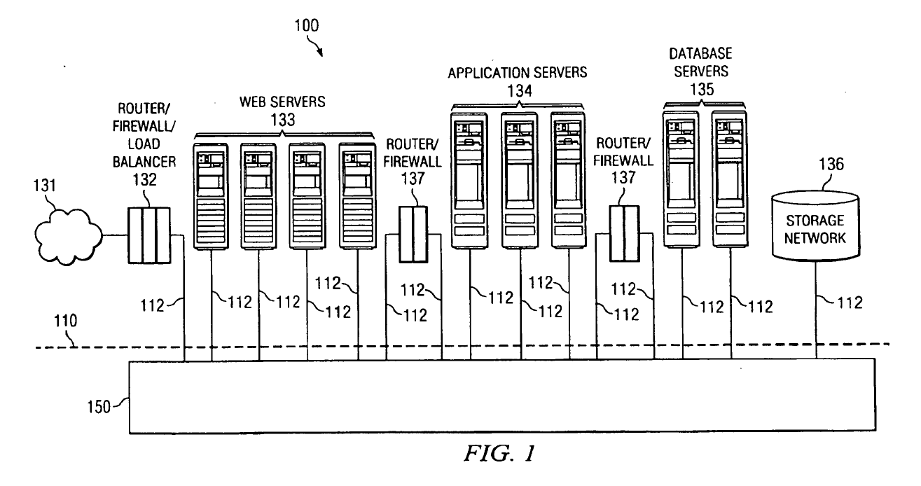

FIG. 1 includes a hardware diagram of a system 100. The system 100 includes an application infrastructure 110, which is the portion above the dashed line in FIG. 1. The application infrastructure 110 includes the Internet 131 or other network connection, which is coupled to a router/firewall/load balancer 132. The application infrastructure further includes Web servers 133, application servers 134, and database servers 135. Other computers may be part of the application infrastructure 110 but are not illustrated in FIG. 1. The application infrastructure 110 also includes storage network 136 and router/firewalls 137. Although not shown, other additional application infrastructure components may be used in place of or in addition to those application infrastructure components previously described. Each of the application infrastructure components 132-137 is bi-directionally coupled in parallel to application management and control appliance (apparatus or appliance) 150. In the case of router/firewalls 137, both the inputs and outputs from such router/firewalls are connected to the appliance 150. Substantially all the traffic for application infrastructure components 132-137 in application infrastructure 110 is routed through the appliance 150 using network. Software agents may or may not be present on each of application infrastructure components 132-137. The software agents can allow the appliance 150 to monitor, control, or a combination thereof at least a part of any one or more of application infrastructure components 132-137. Note that in other embodiments, software agents may not be required in order for the appliance 150 to monitor or control the application infrastructure components.

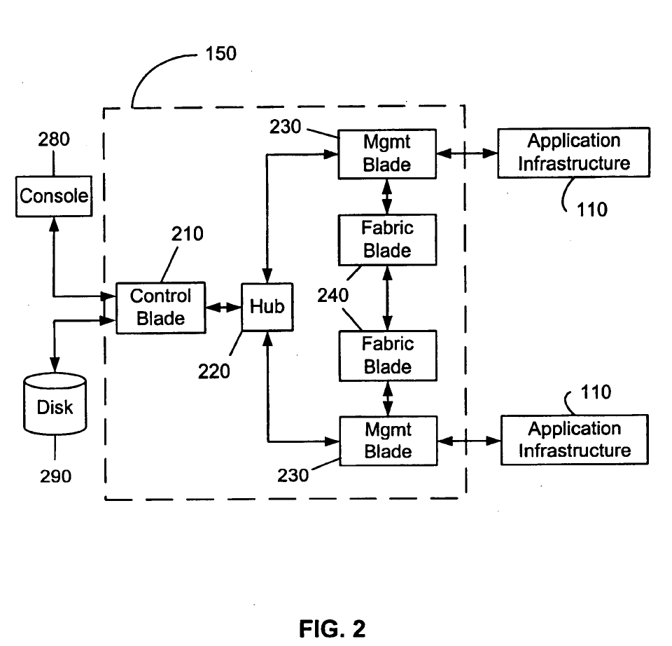

FIG. 2 includes a hardware depiction of appliance 150 and how it is connected to other components of the system. The console 280 and disk 290 are bi-directionally coupled to a control blade 210 within the appliance 150. The console 280 can allow an operator to communicate with the appliance 150. Disk 290 may include data collected from or used by the appliance 150. The appliance 150 includes a control blade 210, a hub 220, management blades 230, and fabric blades 240. The control blade 210 is bi-directionally coupled to a hub 220. The hub 220 is bi-directionally coupled to each management blade 230 within the appliance 150. Each management blade 230 is bi-directionally coupled to the application infrastructure 110 and fabric blades 240. Two or more of the fabric blades 240 may be bi-directionally coupled to one another.

Although not shown, other connections may be present and additional memory may be coupled to each of the components within appliance 150. Further, nearly any number of management blades 230 may be present. For example, the appliance 150 may include one or four management blades 230. When two or more management blades 230 are present, they may be connected to different parts of the application infrastructure 110. Similarly, any number of fabric blades 240 may be present and under the control of the management blades 230. In another embodiment, the control blade 210 and hub 220 may be located outside the appliance 150, and nearly any number of appliances 150 may be bi-directionally coupled to the hub 220 and under the control of control blade 210.

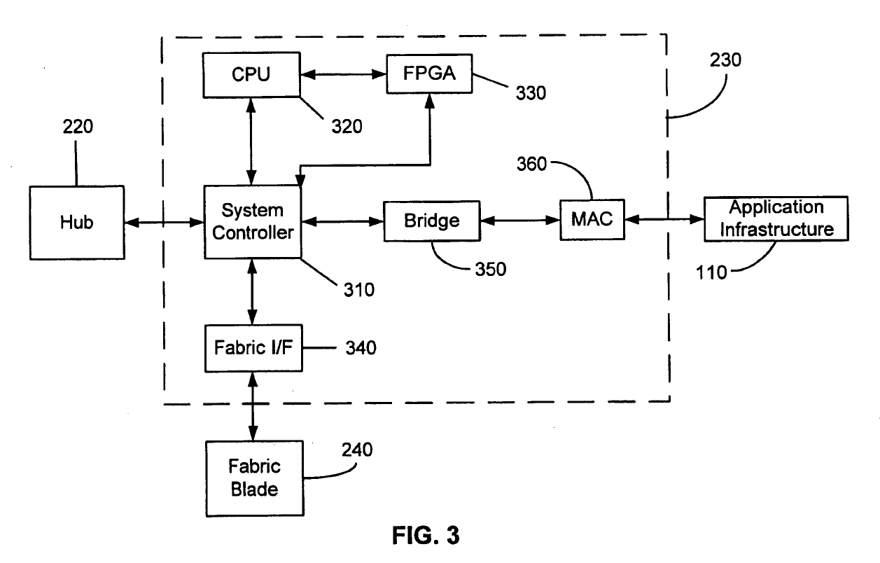

FIG. 3 includes an illustration of one of the management blades 230, which includes a system controller 310, central processing unit (“CPU”) 320, field programmable gate array (“FPGA”) 330, bridge 350, and fabric interface (“I/F”) 340, which in one embodiment includes a bridge. The system controller 310 is bi-directionally coupled to the hub 220. The CPU 320 and FPGA 330 are bi-directionally coupled to each other. The bridge 350 is bi-directionally coupled to a media access control (“MAC”) 360, which is bi-directionally coupled to the application infrastructure 110. The fabric I/F 340 is bi-directionally coupled to the fabric blade 240.

More than one of any or all components may be present within the management blade 230. For example, a plurality of bridges substantially identical to bridge 350 may be used and bi-directionally coupled to the system controller 310, and a plurality of MACs substantially identical to MAC 360 may be used and bi-directionally coupled to the bridge 350. Again, other connections may be made and memories (not shown) may be coupled to any of the components within the management blade 230. For example, content addressable memory, static random access memory, cache, first-in-first-out (“FIFO”) or other memories or any combination thereof may be bi-directionally coupled to FPGA 330.

The appliance 150 is an example of a data processing system. Memories within the appliance 150 or accessible by the appliance 150 can include media that can be read by system controller 310, CPU 320, or both. Therefore, each of those types of memories includes a data processing system readable medium.

Portions of the methods described herein may be implemented in suitable software code that may reside within or accessibly to the appliance 150. The instructions in an embodiment of the present invention may be contained on a data storage device, such as a hard disk, a DASD array, magnetic tape, floppy diskette, optical storage device, or other appropriate data processing system readable medium or storage device.

In an illustrative embodiment of the invention, the computer-executable instructions may be lines of assembly code or compiled C⁺⁺, Java, or other language code. Other architectures may be used. For example, the functions of the appliance 150 may be performed at least in part by another appliance substantially identical to appliance 150 or by a computer, such as any one or more illustrated in FIG. 1. Additionally, a computer program or its software components with such code may be embodied in more than one data processing system readable medium in more than one computer.

Communications between any of the components in FIGS. 1-3 may be accomplished using electronic, optical, radio-frequency, or other signals. When an operator is at the console 280, the console 280 may convert the signals to a human understandable form when sending a communication to the operator and may convert input from a human to appropriate electronic, optical, radio-frequency, or other signals to be used by and one or more of the components.

Attention is now directed to methods and systems for obtaining information regarding application infrastructure components in an application infrastructure. These systems and methods may obtain information regarding these application infrastructure components and assemble information on the application infrastructure topology from this information. To obtain information on these application infrastructure components, these methods and systems may observe the traffic flowing across the network by receiving a communication originating with, or intended for, an application infrastructure component and examining this communication. Information may also be obtained by querying agents resident on the various application infrastructure components. These application infrastructure components may be queried via the protocol utilized by the application infrastructure on which the application infrastructure components reside.

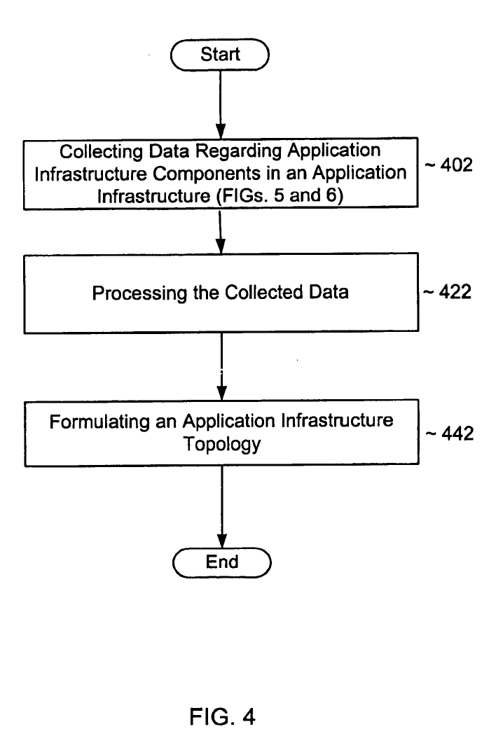

A software architecture for implementing systems and methods for assembling information on an application infrastructure topology is illustrated in FIG. 4. These systems and methods may include collecting information regarding application infrastructure components in an application infrastructure (block 402), processing this collected data (block 422), and formulating an application infrastructure topology based on the collected data (block 442).

Many different methodologies may be used to collect information about application infrastructure components in the application infrastructure (block 402). These methodologies may include systems and methods which collect information about application infrastructure components by observing traffic on a network and those which collect information by querying an agent on an application infrastructure component.

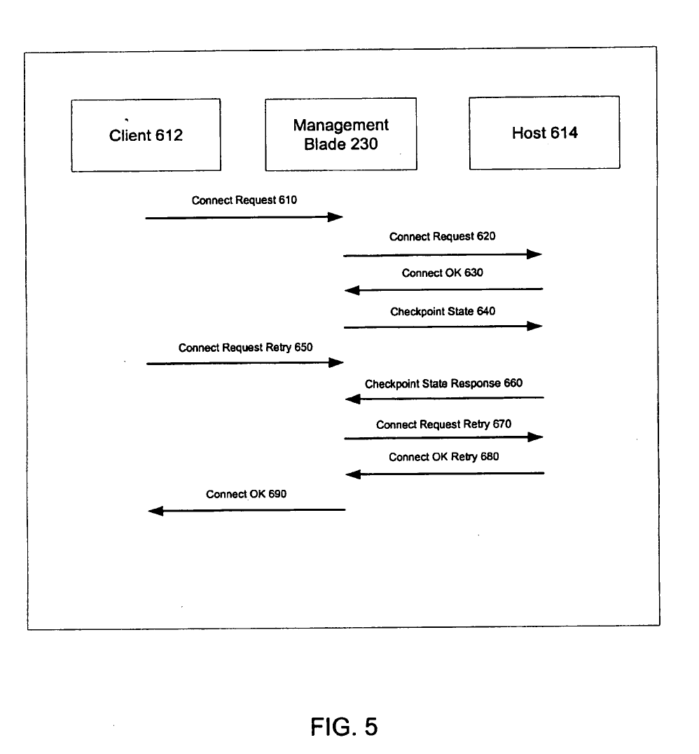

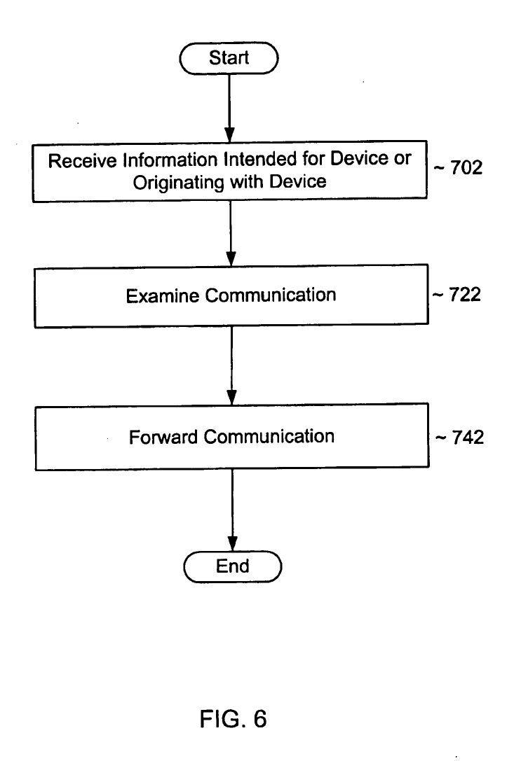

FIGS. 5 and 6 address non-limiting implementations for collecting information about application infrastructure components. FIG. 5 illustrates in more detail an embodiment of a particular system and method for obtaining information on an application infrastructure component by querying an agent residing on the application infrastructure component. The particulars of the protocol used by network 112 may be exploited to issue these queries more efficiently. These method and systems may be implemented by a management component 230 residing in application infrastructure 110 in order to obtain information about a specific device in application infrastructure 110. More particularly, these systems and methods may utilize the particulars of the TCP/IP network protocol to query agents on a device resident in application infrastructure 110 synchronously with the beginning or end of a transaction with the device.

FIG. 5 depicts how a management interface component 230 may obtain information on a particular device or application infrastructure component using the architecture of the TCP/IP protocol. The method illustrated in FIG. 5 is given from the perspective of the management interface component (e.g. management blade 230). In one embodiment, management blade 230 may receive a connection request intended for a device or application infrastructure component on application infrastructure 110. This connection request is then forwarded on to the device. When the device responds to the connection request this response is received by management blade 230. The management blade 230 may then query an agent on the device. Management blade 230 may then receive a substantially identical connection request for the device. After receiving information from the agent on the device in response to the query, the second connection request may be forwarded to the device or application infrastructure component. Management blade 230 may then receive a response to the first or second connection request from the device and forward this response on to the intended recipient.

Management blade 230 may be connected to host 614 and client 612 residing on application infrastructure 110. However, host 614 and client 612 may not be directly coupled to one another, consequently any communication between client 612 and host 614 passes through management blade 230. This architecture, coupled with a TCP/IP network protocol allows management blade 230 to leverage the fact it is in the data path to collect information on host 614 synchronously with the beginning of a network transaction, while causing minimal disturbance to network throughput.

Management blade 230 may receive connect request 610 from client 612 desiring to communicate with a particular application executing on host 614 resident on application infrastructure 110. Upon receiving this connect request 610, management blade can forward this connect request 620 onto host 614. Host 614, or an application infrastructure component residing on host 614, may receive this connection request 620 and open a TCP socket between host 614 and client 612 (or applications residing on host 614 and client 612). This open socket is indicated when host 614 sends connect okay 630 intended for client 612 to management blade 230.

Once a socket is opened on host 614, management blade 230 may query an agent on host 614 by sending checkpoint state 640 to host 614. Agents on host 614, which may be queried by management blade 230, include software host agents installed specifically for the purpose of gathering information on operating system parameters and statistics, application health and status, CPU utilization, filesystem information, client connection statistics, network and transaction statistics, and other information which will be readily apparent to those of ordinary skill in the art. Additionally, the implementation of agents of this type will also be readily apparent to those of ordinary skill in the art after reading this specification.

The presence of existing agents on host 614 may also be exploited by management blade 230 and may obviate the need for the installation of proprietary software agents. For example, Simple Network Management Protocol (SNMP) may be implemented by network 112 on which host 614 is resident. By querying the SNMP software resident on host 614, management blade 230 may obtain information on network parameters and I/O rates, SNMP statistics, client connection statistics, etc. Common Information Model (CIM) may provide another agent of this type. If CIM is implemented on host 614, by querying the software application associated with CIM and resident on host 614, management base 230 may obtain information on storage statistics, network information, application status, etc. Other non-proprietary agents of this type may include software applications executing on host 614 such as an Oracle database application or the like. Those of ordinary skill in the art will realize the number and variety of agents which may reside on host 614, how management blade 230 may query these various agents, and the type and quantity of information which agents residing on host 614 may provide in response to queries from management blade 230.

After receiving a reply to checkpoint state 640, management blade may forward connect-okay 630 to intended recipient, client 612. Because of the nature of TCP/IP, however, after a certain amount of time client 612 will conclude that its first connect request 610 has been dropped by network 112 and will send connect request retry 650 to host 614. After receiving checkpoint state response 660, management blade 230 may forward connect request retry 670 onto host 614, which may issue a connect-okay retry 680 in response. In turn, management blade 230 may forward this connect-okay retry response 690 to client 612.

Note that not all of the activities described in FIGS. 4-6 are necessary, that an element within a specific activity may not be required, and that further activities may be performed in addition to those illustrated. Additionally, the order in which each of the activities is listed is not necessarily the order in which they are performed. After reading this specification, a person of ordinary skill in the art will be capable of determining which activities and orderings best suit any particular objective. For example, many of the requests and responses depicted in FIG. 5 are not required, and it is of little consequence when checkpoint state response 660 is received by management blade 230, as long as the response is sent from host 614 before the socket is closed.

Moving on to FIG. 6, a flow diagram for another embodiment of a method for collecting information on an application infrastructure component or device in application infrastructure 110 (block 402 in FIG. 4) is depicted. While agents are useful for collecting information about operations performed completely inside a single host, management blade 230 may leverage its position in the data path to collect information on devices or application infrastructure components in application infrastructure 110 without interaction with those devices or application infrastructure components other then receiving and forwarding communication between application infrastructure components connected to the network 112. In many cases, devices connected to network 112 are not connected to one another, consequently communications between devices usually pass through management blade 230. To collect information on a device or application infrastructure component, a management blade 230 may receive a communication intended for the device or originating with the device (block 702), examine this communication (block 722), and forward this communication on to its intended recipient (block 742). More details regarding FIG. 6 are described below.

Referring to an embodiment illustrated in FIG. 6, management blade 230 receives a communication originating from a device or intended for a device (block 702) connected to network 112. This communication may be assembled into a packet by MAC 360. In certain embodiments, these packets may conform to the Open Systems Interface (OSI) seven layer standard. In one embodiment the packets assembled by MAC 360 are TCP/IP packets.

These packets may then be examined by management blade 230 (block 722). By analyzing different layers of the packet received by management blade 230 information can be gleaned on the device or application infrastructure component from which the communication is originating, or the device or application infrastructure component for which the communication is intended. A few things that may be deduced from examining the packets flowing through management blade 230 include status of the device, which may be determined by monitoring the link state and network responses from the device. Host names and IP addresses can also be determined by examining the unique ID (such as a MAC address) and a well known handle (IP address) contained in various layers of the packet received by management blade 230. By similar methods many network parameters such as host names, network masks, default gateways etc. can be inferred from received packets.

Application and transaction information may also be gathered by examining packets received by management blade 230 (block 722). By inspecting the packet received by management blade 230 for well-known ports, a deduction may be made that a particular application or a client of a particular application is installed on a device in application infrastructure 110. Communications intended for these applications also allow management blade 230 to infer if an application is up, down, or malfunctioning by monitoring service requests and response times. If the response to a communication intended for an application is port unreachable, the application may be down. If there is no response, the application may be malfunctioning. If the response is TCP Reset, the application may have reached its service limit.

In a similar vein, by observing packets flowing between applications and their clients residing on devices in application infrastructure 110, application specific network traffic statistics can be calculated. By observing long term service response times of applications running on a particular device, CPU utilization may be determined by management blade 230 based on the number of concurrently active transactions. Using analogous information gleaned from examination of a packet (block 722), average service times of applications may be estimated, and client connection statistics such as maximum client capacity may be gauged. Those of ordinary skill in the art will realize that by receiving a communication originating with, or intended for, a device (block 702) and analyzing this communication (block 722), a multiplicity of information may be gathered or estimated about devices or application infrastructure components in application infrastructure 110 without the use of any type of agent residing on devices in application infrastructure 110.

After management blade 230 has received the communication (block 702), and is done examining the communication (block 722), the communication may be forwarded on to the intended recipient (block 742), usually another device in application infrastructure 110. In the manner depicted here and in FIG. 5, information may be collected about devices or application infrastructure components in application infrastructure 110.

Returning now to FIG. 4, after information is collected about these devices or application infrastructure components (block 402), this information may be processed by management blade 230 (block 422). This processing may include determining the physical devices associated with management blade 230 such as hosts, routers, servers, printers etc.; the logical resources associated with each device such as web servers, applications, Oracle database, operating system versions etc.; and how they interrelate with one another, including physical and logical connections between devices and various application and client software executing on devices in application infrastructure 110. In certain embodiments, processing information (block 422) may include collating and assembling information collected on individual devices or application infrastructure components in application infrastructure 110 by management blade 230.

After the collected information is processed (block 422), an application infrastructure topology of application infrastructure 110 may be assembled (block 442). This application infrastructure topology may consist of the interrelationships between physical devices, logical devices and transactional entities in application infrastructure 110, and may be a graph of these relationships. In one particular embodiment, this application infrastructure topology may be represented in a framework consisting of two distinct types of elements; nodes and arcs. A node may describe a physical, logical, or transactional entity. An arc may link two particular nodes together with a specific type of relationship. This framework, and the various nodes and arcs which comprise the framework, may be represented in software data structures. An example of such a software structure is depicted in Example 1.

A representation of an application infrastructure topology may be assembled (block 442) by management blade 230 regarding application infrastructure 110 to which it is coupled. Additionally control blade 210 may collect information from management blade 230 and assemble a representation of an application infrastructure topology regarding application infrastructure 110.

### EXAMPLE

Specific embodiments of the invention will now be further described by the following, nonlimiting example which will serve to illustrate in some detail various features. The following examples are included to facilitate an understanding of ways in which the invention may be practiced. Readers will appreciate that the examples which follow represent embodiments discovered to function well in the practice of the invention, and thus can be considered to constitute preferred modes for the practice of the invention. However, many changes can be made in the exemplary embodiments which are disclosed while still obtaining like or similar result without departing from the scope of the invention. Accordingly, the example should not be construed as limiting the scope of the invention.

### Example 1

The following data structure illustrates a data structure which may be used to represent the nodes and arcs contained in a graph representation of an application infrastructure topology.

/*
* a_hdr_t
* This structure contains generic header information that prefixes
* each node or arc entry.
*
*/
typedef a_hdr
{

| | | |
|---|---|---|
| uint8_t flags; | /* See AHF_* for details | */ |
| uint8_t type; | /* Type of entry. See AHT_* | */ |
| uint16_t gen; | /* Generation number - Detects stale arcs | */ |
| uint16_t refs; | /* Reference count - 0=free | */ |
| uint16_t size; | /* Size of the data owned by this object | */ |
| uint16_t qual; | /* Key qualifier; not normally used | */ |
| uint32_t key; | /* Type specific key used for lookups | */ |
| uint32_t acc_cnt; | /* Accesses to object (stops at 0xffffffff) | */ |
| uint32_t index; | /* Index into appropriate array of this object | */ |
| uint32_t next; | /* Next index for various chains | */ |
| uint32_t prev; | /* Previous index for various chains */ | |
| uint32_t u_time; | /* Time of last object contents update | */ |
| } a_hdr_t; | | |

| | | |
|---|---|---|
| #define AHF-NODE (0x01) | /* Header is for a node (not arc) | */ |
| #define AHF-PHYS (0x02) | /* Object described is physical | */ |
| #define AHF-LOGL (0x04) | /* Object described is logical | */ |
| #define AHF-TRAN (0x08) | /* Object described is transactional | */ |

| | | | |
|---|---|---|---|
| #define AHT_NODE_UNDEF | ( 0) | /* Object type is not yet known | */ |
| #define AHT_NODE_HOST | ( 1) | /* Object is a host | */ |
| #define AHT_NODE_IFACE | ( 2) | /* Object is a network interface | */ |
| #define AHT_NODE_FILE | ( 3) | /* Object is a file | */ |
| #define AHT_NODE_SOCKET | ( 4) | /* Object is a network socket | */ |
| #define AHT_NODE_IPC | ( 5) | /* Object is a node specific IPC | */ |
| #define AHT_NODE_PROC | ( 6) | /* Object is a process | */ |
| #define AHT_NODE_DISK | ( 7) | /* Object is a data storage device | */ |
| #define AHT_NODE_SERV | ( 8) | /* Object is a host service | */ |
| #define AHT_NODE_IPADDR | ( 9) | /* Virtual IP address on an IFACE | */ |
| #define AHT_NODE_ROUTE | ( 10) | /* A description of a network route | */ |
| #define AHT_NODE_USER | ( 11) | /* A description of a user | */ |
| #define AHT_NODE_GROUP | ( 12) | /* A description of a group | */ |
| #define AHT_NODE_REG | ( 13) | /* Windows registry entry | */ |
| #define AHT_ARC_UNDEF | (128) | /* Object type is not yet known | */ |
| #define AHT_ARC_LINK | (129) | /* Link between two objects | */ |
| #define AHT_ARC_MEMBER | (130) | /* Left is thread in process Right | */ |
| #define AHT_ARC_EXEC | (131) | /* Left is executing Right | */ |
| #define AHT_ARC_ON | (132) | /* Left is contained by Right | */ |
| #define AHT_ARC_CHILD | (133) | /* Left thread is child of Right | */ |
| #define AHT_ARC_USER | (134) | /* Left is the user owning Right | */ |
| #define AHT_ARC_GROUP | (135) | /* Left is the group owning Right | */ |
| #define AHT_ARC_IFACE | (136) | /* Left is network iface on Right | */ |
| #define AHT_ARC_USING | (137) | /* Left is using Right | */ |

The header contains access counts and timestamps (second granularity) to allow for historical processing. The data structure that contains NODE information can appear as follows:

typedef a_hdr
{
a_hdr_t hdr;

| | | |
|---|---|---|
| uint32_t *hash_table; | /* Pointer to base of hash table | */ |
| uint32_t hash; | /* If hashed, then this is bucket index | */ |

```
  uint32_t hash_table_size;
  uint8_t data[AN_DATA_SIZE];
} a_node_t;
```

The data in each NODE is specific to the type of node. Below is an example of the type specific instance data:

/*
* an_host_t
*
* KEY
* The key for a host is a hash of the unqualified host name. If there
* is not host name, an ASCII representation of the lowest valued IP
* address on the system is used and the key is a hash of that.
*
* NOTES
* The ‘scale_mips’ field is an arbitrary host processing value. The
* details of how it is calculated are TBD. In theory, a host with a
* scale_mips=X value would be able to process roughly ½ the
* transactions of a host with scale_mips=2X. In theory. Much hand
* waving.
*/
typedef an_host

| | | |
|---|---|---|
| { | /* Version of data; See ANHO_VER | */ |
| uint16_t version; | /* Bit map of valid fields; ANHOV_* | */ |
| uint16_t valid; | /* UP time in seconds | */ |
| uint64_t uptime; | /* Number of processors | */ |
| uint8_t processors; | /* CPU Type; ANHOC_* | */ |
| uint8_t cpu_type; | /* Node type; AHNOT_* | */ |
| uint8_t host type; | /* Relative host processing metric | */ |
| uint32_t scale_mips; | /* Physical memory in MB | */ |
| uint32_t memory; | /* Swap space in MB | */ |
| uint32_t swap; | /* OS type; ANHOS_* | */ |
| uint32_t os_version | /* AABBCCDD = A.B-C-D | |
| uint8_t name [1]; | /* 0 terminated host name | |
| } an_host_t; | | |

#define ANHO_VER (1)

| | |
|---|---|
| #define ANHOV_UPTIME | (0x0001) |
| #define ANHOV_PROCESSOR | (0x0002) |
| #define ANHOV_CPU_TYPE | (0x0004) |
| #define ANHOV_SCALE_MIPS | (0x0008) |
| #define ANHOV_MEMORY | (0x0010) |
| #define ANHOV_SWAP | (0x0020) |
| #define ANHOV_OS_TYPE | (0x0040) |
| #define ANHOV_OS_VERSION | (0x0080) |
| #define ANHOV_NAME | (0x0100) |

| | | | |
|---|---|---|---|
| #define ANHOC_x86 | (1) | | |
| #define ANHOC_SPARC | (2) | | |
| #define ANHOC_POWERPC | (3) | | |
| #define ANNOT_SERVER | (1) | /* Host is a ‘computer’ | */ |
| #define ANNOT_MBLADE | (2) | /* Host is VIEO M-Blade | */ |
| #define ANNOT_SWITCH | (3) | /* Host is generic Ethernet | */ |
| | | switch | |
| #define ANNOT_ROUTER | (4) | /* Host is generic IP Router | */ |
| #define ANHOS_LINUX | (1) | | |
| #define ANHOS_NT | (2) | | |
| #define ANHOS_WIN2K | (3) | | |
| #define ANHOS_WINXP | (4) | | |
| #define ANHOS_WINOTHER | (5) | /* ‘Other’ Microsoft OS | */ |
| | | version | |
| #define ANHOS_SOLARIS | (6) | | |
| #define ANHOS_AIX | (7) | | |
| #define ANHOS_HPUX | (8) | | |

The arc object contains the header, left and right pointers, and some book keeping information that allows lazy garbage collection. The “weight” field allows mixing of deterministic data (weight=100) with probabilistic (0-100) information generated in other parts of the system.

typedef a_arc
{
a_hdr_t hdr;;

| | | |
|---|---|---|
| uint32_t left; | /* Index into NODE array of one side of link | */ |
| uint32_t left_gen; | /* Generation number of NODE on one side | */ |
| uint32_t right; | /* Index into NODE array of other size | */ |
| | of link | |
| uint32_t right_gen; | /* Generation number of NODE on the | */ |
| | other side | |
| uint8_t weight; | /* ‘Reliability’ value; 0=rumor, 100=fact | */ |

uint8_t data[AA_DATA_SIZE];
} a_arc_t;

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A method of collecting data regarding an application infrastructure component coupled to an application infrastructure, comprising:
receiving a communication pertaining to the application infrastructure component;
examining the communication to obtain a characteristic of the application infrastructure component; and
forwarding the communication.

2. The method of claim 1, wherein the communication is intended for the application infrastructure component and the communication is forwarded to the application infrastructure component.

3. The method of claim 1, wherein the communication originates with the application infrastructure component and the communication is forwarded to an intended recipient.

4. The method of claim 1, wherein the communication is a packet adhering to the OSI reference model.

5. The method of claim 4, wherein the packet is a TCP/IP packet.

6. The method of claim 5, wherein examining the communication further comprises examining layers 2, 3, 4, or 7 of the TCP/IP packet.

7. The method of claim 5, wherein the data regarding the application infrastructure component includes at least one of operating system information, network information, the application infrastructure component's CPU utilization, file system information, application information, and hardware information.

8. An apparatus configured to implement the method of claim 1.

9. A method of collecting data regarding an application infrastructure component in an application infrastructure comprising
receiving a first request for an application infrastructure component; and
collecting data on the application infrastructure component, wherein collecting data further comprises sending a second request to the application infrastructure component and receiving a response to the second request from the application infrastructure component.

10. The method of claim 9, further comprising
forwarding the first request to the application infrastructure component; and
receiving a response to the first request from the application infrastructure component.

11. The method of claim 10, further comprising
receiving a third request for an application infrastructure component;
forwarding the third request to the application infrastructure component;
receiving a response to the third request from the application infrastructure component; and
forwarding the response to the third request to the intended recipient.

12. The method of claim 9, wherein the first request is different from the second request.

13. The method of claim 12, wherein the first request and the third request are substantially identical connection requests.

14. The method of claim 13, wherein the first response and the third response are substantially identical connect-ok responses.

15. The method of claim 14, wherein collecting data on the application infrastructure component further comprises querying an agent residing on the application infrastructure component.

16. The method of claim 15, wherein the data regarding the application infrastructure component includes at least one of operating system information, network information, information on the application infrastructure component's CPU utilization, file system information, hardware information, and application information.

17. An apparatus configured to implement the method of claim 9.

18. A method of collecting data regarding an application infrastructure, comprising:
collecting data regarding one or more devices in the application infrastructure using a component; and assembling information on an application infrastructure topology from the collected information.

19. The method of claim 18, further comprising transmitting data between at least two devices in an application infrastructure.

20. The method of claim 19, wherein collecting data occurs during the transmission of substantially normal data.

21. The method of claim 18, wherein the application infrastructure topology is a physical topology or a logical topology.

22. The method of claim 21, wherein the application infrastructure topology is represented in a graph.

23. An apparatus configured to implement the method of claim 18.

24. A data processing system readable medium having code for collecting data regarding an application infrastructure component on a network, wherein the code is embodied within the data processing system readable medium, the code comprising instructions for:
receiving a communication pertaining to the application infrastructure component;
examining the communication to obtain data regarding the application infrastructure component; and
forwarding the communication.

25. The data processing system readable medium of claim 24, wherein the communication originates with the application infrastructure component and the communication is forwarded to an intended recipient.

26. The data processing system readable medium of claim 25, wherein the communication is a packet adhering to the OSI reference model.

27. The data processing system readable medium of claim 26, wherein the packet is a TCP/IP packet.

28. The data processing system readable medium of claim 27, wherein examining the communication further comprises examining layers 2, 3, 4, or 7 of the TCP/IP packet.

29. The data processing system readable medium of claim 27, wherein the data regarding the application infrastructure component includes at least one of operating system information, network information, the application infrastructure component's CPU utilization, file system information, application information, and hardware information.

30. A data processing system readable medium having code for collecting data regarding an application infrastructure component in an application infrastructure, wherein the code is embodied within the data processing system readable medium, the code comprising instructions for:
receiving a first request for an application infrastructure component; and
collecting data on the application infrastructure component, wherein collecting data further comprises sending a second request to the application infrastructure component and receiving a response to the second request from the application infrastructure component.

31. The data processing system readable medium of claim 30, further comprising instructions for:
forwarding the first request to the application infrastructure component; and
receiving a response to the first request from the application infrastructure component.

32. The data processing system readable medium of claim 31, further comprising instructions for:
receiving a third request for an application infrastructure component;
forwarding the third request to the application infrastructure component;
receiving a response to the third request from the application infrastructure component; and
forwarding the response to the third request to the intended recipient.

33. The data processing system readable medium of claim 30, wherein the first request is different from the second request.

34. The data processing system readable medium of claim 33, wherein the first request and the third request are substantially identical connection requests.

35. The data processing system readable medium of claim 34, wherein the first response and the third response are substantially identical connect-ok responses.

36. The data processing system readable medium of claim 35, wherein collecting data on the application infrastructure component further comprises querying an agent residing on the application infrastructure component.

37. The data processing system readable medium of claim 36, wherein the data regarding the application infrastructure component includes at least one of operating system information, network information, information on the application infrastructure component's CPU utilization, file system information, hardware information, and application information.

38. A data processing system readable medium having code for collecting data regarding an application infrastructure, wherein the code is embodied within the data processing system readable medium, the code comprising instructions for:
collecting data regarding one or more devices coupled to the network using a component; and
assembling information on an application infrastructure topology from the collected information.

39. The data processing system readable medium of claim 38, further comprising instructions for transmitting data between at least two devices in the application infrastructure.

40. The data processing system readable medium of claim 39, wherein collecting data occurs during the transmission of substantially normal data.

41. The data processing system readable medium of claim 38, wherein the application infrastructure topology is a physical topology or a logical topology.

42. The data processing system readable medium of claim 41, wherein the application infrastructure topology is represented in a graph.
